(19) United States
(12) Patent Application Publication
(10) Pub. No.: US 2026/0328173 A1
(43) Pub. Date: Oct. 22, 2026

(54) FUEL PUMP ASSEMBLY

(71) Applicant: PHINIA DELPHI LUXEMBOURG SARL, Belvaux (LU)

(72) Inventors: Paul BUCKLEY, Gillingham Kent (GB); Cynthia Pearlin Jebaraj ENOCH, Gillingham Kent (GB)

(21) Appl. No.: 19/106,795

(22) PCT Filed: Aug. 24, 2023
(86) PCT No.: PCT/EP2023/073312

§ 371 Date: Feb. 26, 2025

(30) Foreign Application Priority Data
Aug. 26, 2022 (GB) 2212448.1

(51) Int. Cl. F02M 59/48; F02M 59/02

(52) U.S. Cl. CPC F02M 59/48; F02M 59/02; F02M 2200/8076

(57) ABSTRACT

A fuel pump assembly comprises a pump head housing and a main pump housing provided with at least a portion of a plunger bore for housing a pumping plunger which pressurizes fuel within a pump chamber defined within the pump head housing. The pump head housing and the main pump housing define a housing interface between facing surfaces thereof. A screw-receiving bore in the main pump housing receives a screw comprising a screw shaft which extends across the housing interface between the main pump housing and the pump head housing, in use, wherein the screw-receiving bore has a screw-threaded region of diameter, D, which interfaces with a screw-threaded region of the screw shaft to define an axially-threaded interface, which is displaced from the housing interface by a distance length, L, wherein a ratio of L/D is greater than or equal to 1.

### TECHNICAL FIELD

The present invention relates to a fuel pump assembly for use in a fuel system of an internal combustion engine. In particular, but not exclusively, the invention relates to a fuel pump assembly for use in a fuel system of compression ignition internal combustion engine.

### BACKGROUND

In a familiar fuel pump assembly for an internal combustion engine (ICE), a compression chamber resides within a pump head which is mounted to the main pump housing, with multiple screws holding the parts together. The main pump housing is provided with a plunger bore for receiving a pumping plunger which also extends into the pump head so that a surface of the pumping plunger is exposed to fuel within the compression chamber. As the pumping plunger is driven to move within the plunger bore, fuel within the compression chamber is pressurised to a high level for delivery to the downstream parts of the fuel system. Typically in ICEs, fuel pressure is in excess of 2000 bar and so, when the compression chamber is pressurised, there is a relatively large force applied to the pump head which tends to lift the pump head from the housing. This creates various problems including a leakage of fuel between the housing parts.

The lifting force is distributed by the main housing and the screws but only a small portion of the force goes to increase the screw tension. The main portion of the force, however, acts to reduce the contact pressure between the main pump housing and the pump head. As a consequence, it is necessary to ensure there are multiple screw connections between the main pump housing and the pump head to ensure the loss of contact force does not lead to a separation of the parts.

It is against this background that the invention has been devised.

### SUMMARY OF THE INVENTION

Against this background, the invention provides a fuel pump assembly for a fuel system of an internal combustion engine, the fuel pump assembly comprising a pump head housing; a main pump housing provided with at least a portion of a plunger bore for housing a pumping plunger which is driven in use to pressurise fuel within a pump chamber defined within the pump head housing. The pump head housing and the main pump housing define a housing interface between facing surfaces thereof. A screw-receiving bore in the main pump housing is configured to receive a screw comprising a screw shaft which extends across the housing interface, in use, wherein the screw-receiving bore has a screw-threaded region of diameter, D, which interfaces with a screw-threaded region of the screw shaft to define an axially-threaded interface, wherein the axially-extending threaded interface is displaced axially from the housing interface by an axially-extending clearance interface defined between the screw-receiving bore and the screw, the axially-extending clearance interface having a distance length, L, and wherein a ratio of L/D is greater than or equal to 1.

For the avoidance of doubt, for the purpose of this description, the axially-extending threaded interface will be taken to mean the axial region between the screw and the corresponding (adjacent) bore where there is a physical engagement between the thread on the screw and the adjacent bore to secure the parts together through screw-threaded engagement. In contrast, the axially-extending clearance interface will be taken to mean the axial region between the screw and the corresponding (adjacent) bore where there is no screw-threaded engagement between the thread on the screw and the adjacent bore.

In the invention, because the load carried by the first few threads is remote from the housing interface (as defined by the ratio L/D being greater than or equal to 1), the load is distributed over a much larger area of the upper face of the housing compared to the prior art arrangement in which the axial threaded interface starts at the housing interface itself. This arrangement improves the sealing pressure between the pump head housing and the main pump housing at the housing interface and reduces the risk of relative movement between the parts. As a consequence, it is possible to use fewer screw connections between the pump head housing and the main housing, reducing part count, overall assembly cost and assembly time.

The screw-receiving bore may be provided with a counter-bore region, which may open at the housing interface, to define the axially-extending clearance interface between the main bore and the screw shaft.

The counter bore region may be provided with a chamber at the housing interface.

The screw-threaded region of the screw-receiving bore may include an extended screw-threaded region which extends beyond the proximal end of the axially-extending threaded interface to the housing interface. The screw may have a screw shaft of reduced diameter relative to the screw-threaded region of the screw shaft to define a clearance interface with the extended screw-threaded region.

The extended screw-threaded region may extend along the full length of the screw-receiving bore.

In one embodiment, the screw-receiving bore may include an enlarged diameter region of the length, L, proximal to the housing interface, which defines the axially-extending clearance interface with the screw shaft.

For example, the screw-threaded region of the screw shaft may extend beyond the axially-extending threaded interface towards the housing interface (i.e. into the enlarged diameter region).

By way of example, the ratio L/D may be greater than or equal to 1.3.

Preferably, the ratio L/D may be between 1 and 1.5.

The measurement, D, represents the major diameter of the screw-threaded region of the screw-receiving bore and is referred to hereinafter as “the diameter of the screw-threaded region of the screw-receiving bore”.

The pump head housing may, for example, be secured to the main pump housing by means of no more than two screws traversing the housing interface. This provides a significant advantage over known arrangements where at least two screws—and typically four screws—are required to ensure an adequate contact force is maintained between the main pump housing and the pump head throughout use.

It will be appreciated that preferred and/or optional features of any aspect of the invention may be incorporated alone or in appropriate combination in any of the other aspects of the invention also.

### BRIEF DESCRIPTION OF THE DRAWINGS

So that the invention may be better understood, reference will now be made by way of example only to the following drawings in which:

FIG. 1 is a side view of a known fuel pump assembly;

FIG. 2 is a side view of a main pump housing and a pump head housing of the fuel pump assembly in FIG. 1;

FIG. 3 is a side view of a main pump housing and a pump head housing of a fuel pump assembly of a first embodiment of the invention;

FIG. 4 is an enlarged view of the interface between the main pump housing and a pump head housing, in an arrangement similar to the embodiment shown in FIG. 3;

FIG. 5 is a further enlarged view of the interface in FIG. 4, to illustrate various dimensions of the screw thread arrangement;

FIG. 6 is a view, similar to FIG. 5, but in which the bore in the main pump housing has a different form and is similar to the embodiment shown in FIG. 3;
FIG. 7 is a top view of the main pump housing in FIGS. 3 to 6; and

FIG. 8 is an alternative embodiment of the invention to that shown in FIGS. 3 to 6.

### DETAILED DESCRIPTION OF THE EMBODIMENTS

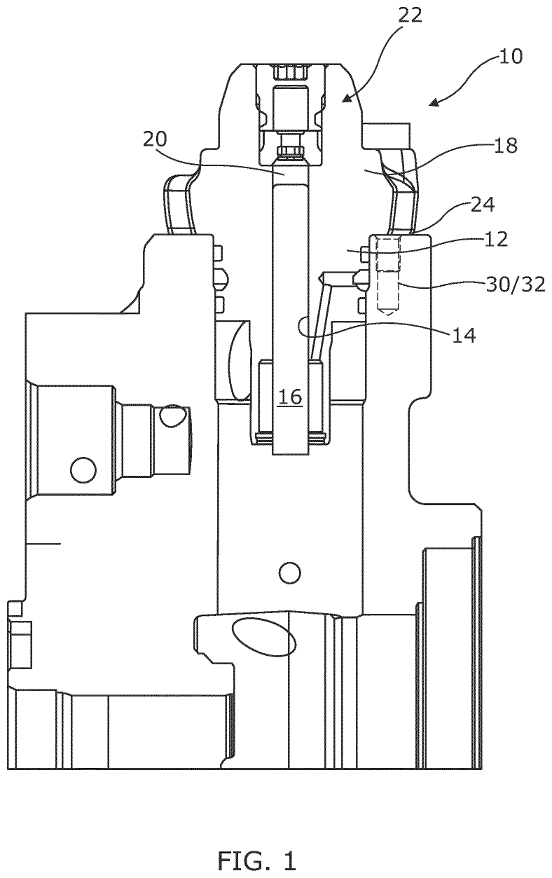

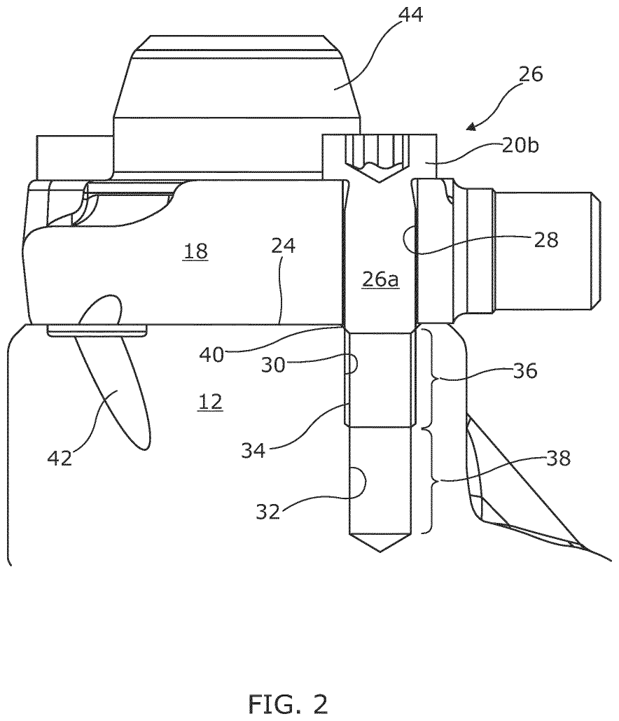

Referring to FIGS. 1 and 2, a fuel pump assembly, referred to generally as 10, for delivering pressurised fuel in a fuel system of an internal combustion engine includes a main pump housing 12 and a pump head 18 (also referred to as a pump head housing). The pump head housing 18 is provided with a bore (a plunger bore 14) for receiving a pumping plunger 16 of the pump assembly. A blind end of the plunger bore 14 in the pump head housing 18 defines, together with an end surface of the pumping plunger 16, a pump chamber 20. An inlet valve arrangement, referred to generally as 22, controls the supply of relatively low pressure fuel into the pump chamber 20 and an outlet valve arrangement (not shown) controls the supply of relatively high pressure fuel from the pump chamber 20 once it has been pressurised.

A shoulder on the pump head housing 18 abuts the main housing 12 to define a housing interface 24 between the housing parts 12, 18. In order to ensure contact between the housing parts at their facing contact surfaces at the housing interface, a plurality of screws are provided to extend through the pump head housing 18 into the main pump housing 12, holding the housing parts securely together with their facing surfaces in contact with one another. FIG. 2 shows an enlarged view of the pump head housing 18 in the region that it engages with the main pump housing 12 at the housing interface 24. In the illustration shown in FIG. 2, only one of the screws 26 is shown but in practice several screws are provided, and are necessary, to ensure contact is maintained between the housing parts 12, 18 through all stages of operation of the fuel pump. For the purpose of the following description, only one of the screws 26 will be described below.

The main pump housing 12 is provided with a main screw-receiving bore (referred to as the main bore) into which a shaft 26a of the screw 26 is received. The screw 26 is provided with a screw head 26b. The pump head housing 18 is provided with a complementary screw-receiving bore 28 which aligns axially with the main bore 30 to allow the shaft 26a of the screw 26 to pass through both housing parts 12, 18, traversing the housing interface 24.

The main bore includes an upper screw-threaded region 30 and a lower unthreaded region 32. The shaft 26a of the screw 26 carries a screw threaded region 36 and an unthreaded region 38. When the screw 26 is received within the main bore 30, 32, a screw-threaded interface 34 is defined axially between the screw-threaded region 36 of the screw 26 and the screw-threaded region 30 of the main bore. Importantly, in FIG. 2 which shows a known arrangement, the screw-threaded region 30 of the main bore starts almost immediately at the housing interface 24 (except for a small chamfer 40 at the opening into the main bore). The screw-threaded region 30 of the main bore extends approximately half way along the bore length.

In use, fuel is supplied to the pump chamber 20, at relatively low pressure, via the inlet valve arrangement (the cap 44 of the inlet valve arrangement is shown in FIG. 2). As the pumping plunger 16 is driven to reciprocate within the plunger bore 14, fuel is drawn into the pump chamber 20 and is pressurised, to a relatively high level, before being delivered through the outlet valve arrangement (not shown) to the downstream parts of the fuel system. Typically, the fuel may be pressurised to a level in excess of 2000 bar. At such high pressure levels, a force tends to lift the pump head housing 18 from the main pump housing 12, as described previously. Although a small portion of the force contributes to increase the tension in the screw threaded connection 30, 36, the majority of the force goes to reduce the contact pressure between the pump head housing 18 and the main housing 12, tending to separate the housing parts. Because of this, it has previously been necessary to include at least four screws to secure the pump head housing 18 to the main housing 12 to prevent separation and leakage problems from the resultant lift force. It can be seen in FIG. 2 that a low pressure passage 42 opens at the housing interface 24 so that separation of the housing parts 12, 18 can result in leakage of fuel from the passage 42, which is undesirable.

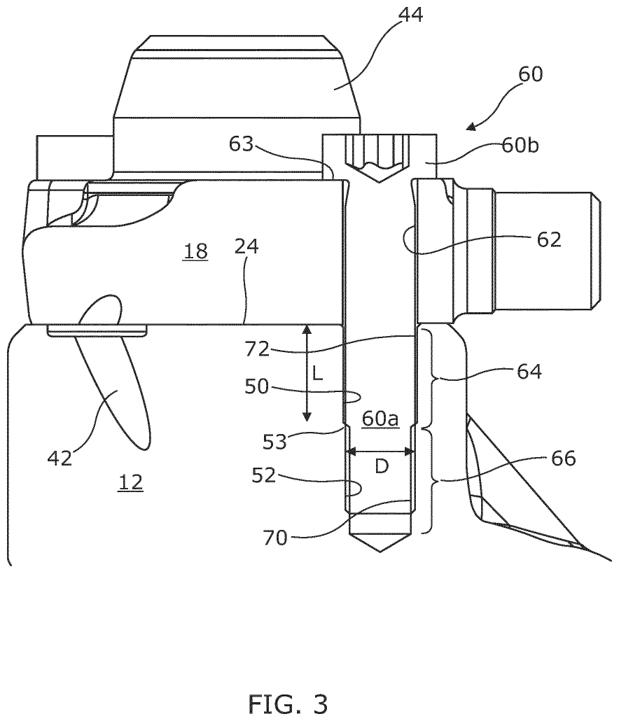

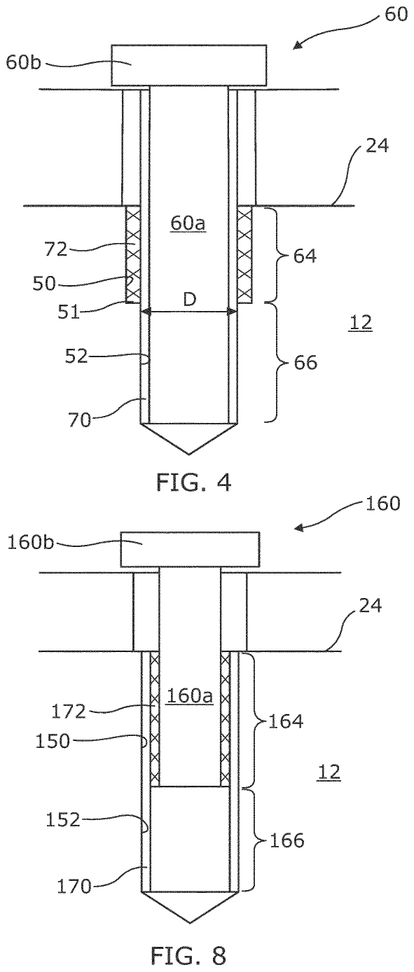

Referring to FIG. 3, the present invention addresses the aforementioned problem by providing a novel and innovative screw-receiving arrangement in the main pump housing to limit the tendency of the housing parts 12, 18 to separate. FIG. 4 is an enlarged and exaggerated view of a similar arrangement to FIG. 3, to show the housing interface 24 between the main pump housing 12 and the pump head housing 18 with greater emphasis. Similar reference numbers for corresponding features to those shown in FIGS. 1 and 2 are used in FIGS. 3 and 4 also, and those features will not be described in further detail.

The pump head 18 is located on the main pump housing 12 and facing surfaces thereof engage to define the housing interface 24. The main pump housing 12 is provided with a screw-receiving bore (referred to as the main bore) including an upper axial portion 50 and a lower axial portion 52. Importantly, and in contrast to the prior art arrangement in FIG. 2, the upper axial portion 50 in FIG. 3 is defined by a counter bore (hereinafter referred to as the counter bore region) which does not carry a screw thread (i.e. an unthreaded region of the main bore). The main bore therefore only carries a screw thread in the lower region 52 (hereafter referred to as the threaded region 52 of the main bore). The counter bore 50 may be provided with a chamfer (not shown) at its open end at the housing interface 24 to aid insertion of the screw into the main bore. The same is true in FIG. 4. The only difference between FIG. 3 and FIG. 4 is that in FIG. 4 the transition between the upper axial portion 50 and the lower axial portion 52 is a stepped transition to define a step 51 along the bore, whereas in FIG. 3 the transition is a sloping transition to define a slope 53 along the bore.

Referring again to FIG. 3, the screw 60 includes a screw shaft 60a and a screw head 60b, with the screw shaft 60a extending through the main bore in the main housing 12 and also through a corresponding bore 62 in the pump head 18 so that the screw head 60b projects through the end of the bore 62 in the pump head 18 to engage with the upper surface 63 thereof. That portion of the screw shaft 60a which extends into the main bore includes an upper region 64 and a lower region 66, wherein the lower region 66 only carries a screw-thread (hereinafter referred to as the screw-threaded region 66 of the screw shaft).

The lower threaded region 52 of the main bore and the screw-threaded region 66 of the screw shaft 60a together define an axially-extending screw-threaded interface 70 between the screw 60 and the main housing 12, wherein the end of the axially-extending screw-threaded interface 70 closest to the housing interface 24 is distanced from the housing interface 24 by a distance, L, equal to the length of the counter bore region 50.

The counter bore region 50 of the main bore and the unthreaded region 64 of the screw shaft 60a define an axially-extending clearance interface 72 of axial length distance, L. The diameter, D (the major diameter), of the threaded region 52 of the main bore is also identified. In other words, due to the upper region 50 of the main bore defining a clearance interface 72 with the upper region of the screw shaft 60a, the screw-threaded engagement between the screw shaft 60a and the main bore does not start until at least a distance L from the housing interface 24. The relationship, L/D is greater than or equal to 1, is satisfied where L is the length of the clearance and D is the major diameter of the screw threaded region 52 of the main bore in threaded engagement with the screw shaft 60a.

The presence of the counter bore region 50 means that a “first” screw turn of the screw threaded region of the screw shaft 60a (that screw turn closest to the interface 24) is displaced a distance, L, from the housing interface 24.

An enlarged view of the main bore 50, 52 is shown in FIG. 5 to illustrate various parameters of the screw threaded engagement which are useful for defining the ratio, L/D. FIG. 5 shows the screw thread having a pitch, P, which is the axial distance of a single helix of the screw thread measured along the axis A-A of the screw thread. PD represents the pitch diameter. The screw thread extends, perpendicular to the axis A-A of the screw thread, between a major diameter D of the screw thread and a minor diameter d of the screw thread. The major diameter D represents the maximum diameter of the screw thread measured perpendicular to the axis A-A of the screw thread. The line M-M represents the line parallel to the axis A which defines the boundary of the maximum diameter D of the screw thread. The line M-M intersects the step 51 at a point Q. The length L of the upper portion 50 of the bore is defined between the interface 24 between the main housing 12 and the pump head housing 18 and the point of intersection, Q.

In another embodiment, as shown in FIG. 6 (and as in FIG. 3), the upper portion of the bore 50 is sloped in the transition region 53 between the upper axial portion 50 of the bore and the lower axial portion 52 of the bore. All other definitions are the same as in FIG. 5. The diameter D is defined as the major diameter of the threaded region 52 of the main bore. The length L is the length of the upper portion of the bore 50 which does not carry a screw thread, defined between the interface 24 up until the point of intersection Q between the axis M-M defining the major diameter D with the sloping surface 53.

As described further below, in reality and considering manufacturing tolerances, the upper region 64 of the screw shaft 60a (which does not carry a screw thread) may be slightly shorter than the counter bore 50, with the lower region 66 of the screw shaft (which carries the screw thread) may be slightly longer than the lower screw-threaded region 52 of the bore. The slight extension of the lower threaded region 66 of the screw shaft into the counter bore 50 does not matter because of the clearance at the counter bore 50. In fact, in other embodiments the upper region 64 can be threaded along the whole length to suit the manufacturing and tolerances, but in any case providing that there is no screw threaded interface until engagement at the lower regions 52/66. There may be a manufacturing benefit if the screw thread on the screw shaft extends over the majority of its length.

It is important that the axially-extending clearance interface 72 extends over a length, L, which satisfies the relationship L/D is greater than or equal to 1. In one example, if the diameter of the screw-threaded region 66 of the screw shaft 60a is 8 mm (referred to as an M8 screw, with a major diameter of 8 mm), the length L of the clearance interface 72 is 10.5 mm. In other words, a first screw turn of the screw threaded region 66 of the screw shaft 60a is displaced axially by approximately 10.5 mm from the housing interface 24 by the counter bore region 50. In this scenario the ratio L/D is 1.3, satisfying the requirement for L/D to be greater than or equal to 1, where D is the major diameter of the screw-threaded region 66 of the screw shaft 60a. The L/D ratio may be slightly greater or slightly less than 1.3, in practice. For example, L/D may be between 1.25 and 1.35.

The nominal major diameter D of a screw denoted as M8 is 8 mm, although in practice the diameter may be slightly less or more (e.g. 7.95 mm) due to manufacturing tolerances. The ratio L/D is calculated based on the nominal major diameter of the screw thread and in the invention an M8 screw is typical. It will be appreciated that a screw denoted M8 uses the metric system (corresponding to 8 mm), whereas in the imperial system the screw thread may be denoted as 5/16 inches.

The clearance bore in the pump head housing 18 will be of similar dimension, with a diameter of between 8 mm and 8.2 mm. In the illustration shown in FIG. 3, for example, and purely by way of example, the major diameter of the screw-threaded region 52 of the bore is around 8 mm and the diameter of the counter bore 50 is around 8.2 mm. In other embodiments the upper portion of the bore 50 to define the clearance 72 may be as much as 9-10 mm for a screw thread diameter D of around 8 mm.

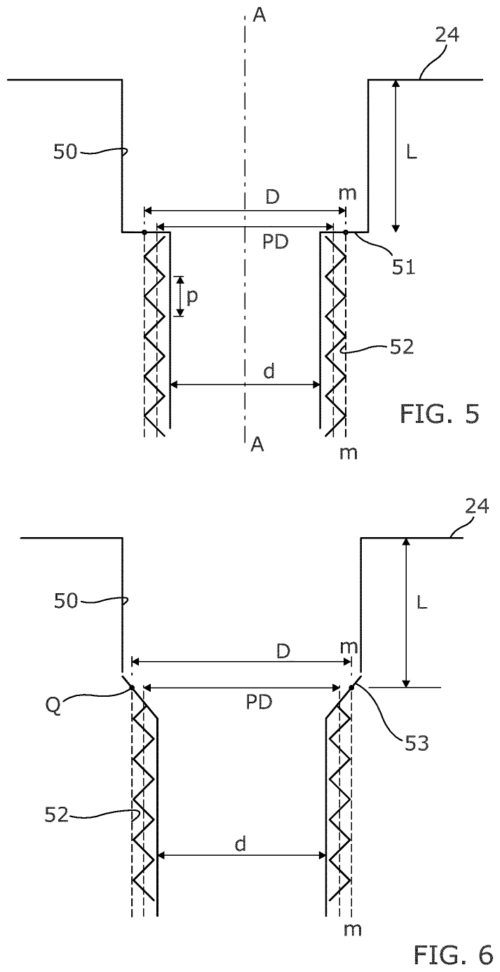

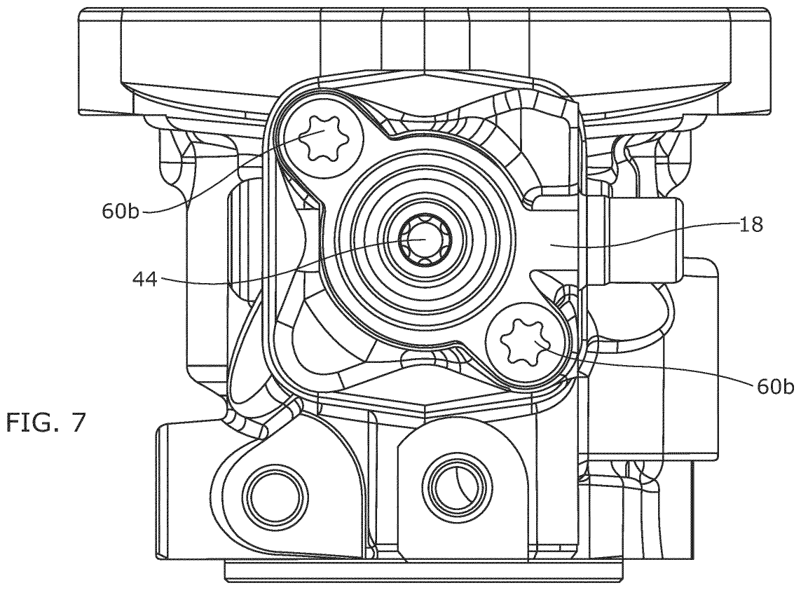

A benefit of the invention is that only two screws are required to secure the pump head housing 18 on the main housing 12, as illustrated in FIG. 5, because the lifting force applied to the pump head housing 18 during pressurisation of the pump chamber is dispersed more widely through the housing 12 by the presence of the counter bore region 50. In FIG. 7 it can be seen that first and second screws 60b are arranged diametrically opposite one another on either side of the inlet valve cap 44. In the two remaining diametrically opposed positions, where further screws are necessary in the prior art arrangement, there is no need for additional screws to traverse the housing interface 24, limiting the part count and freeing space for additional features if required.

In an alternative embodiment of the invention, as shown in FIG. 8, the screw 160 has a stepped diameter along its length, with a screw threaded region 166 only at the lower end and a reduced diameter region 164 (unthreaded) at its upper end. The screw-threaded region 152 of the main bore includes an extended screw-threaded region 150 which extends along the full length of the main bore, with a uniform diameter. This may provide for ease of manufacture as there is no need for a counter bore as in FIGS. 3 to 6. However, it is necessary to ensure the screw shaft 160a is sized so as to create an axial clearance region 172 with the extended screw-threaded region 150, before the screw-threaded interface 170 starts, and this is ensured by the step in the diameter of the screw shaft 160a. In other words, the shaft 160a of the screw 160 is of reduced diameter, in its upper region 164, so as to ensure there is an axial clearance 172 between the extended screw-threaded region 150 of the main bore (of length L) and the adjacent region of the screw shaft 160a. In this way, the axially-extending threaded interface 170 between the lower region of the screw shaft 160a and the main bore 152 is displaced from the housing interface 24 at a distance, L, as for the previous embodiment, with L measured between the interface 24 and the point of intersection Q defined previously. The relationship between L and D (L/D is greater than or equal to 1) is satisfied, where L is the length of the clearance and D is the diameter of the screw threaded region 152 of the main bore which engages with the screw shaft 160a.

This arrangement in FIG. 8 may be easier to manufacture than the previous embodiment as the main bore can be formed with the screw thread 150, 152 along the full length and there is no need for the counter bore.

It will be appreciated that a compromise of FIG. 8 may be used (not shown) where the extended screw threaded region 150 of the main bore extends only part way along the bore length, but not the full way to the housing interface 24. In other words, the extended screw-threaded region 150 extends beyond the proximal end, relative to the housing interface 24, of the axially-extending threaded interface 170.

In any of the embodiments the screw-receiving bore may be provided with a chamfer (not shown) at the entry end of the bore, proximal to the housing interface 24.

It will be appreciated that further embodiments of the invention may be realised without departing from the scope of the appended claims.

### LIST OF PARTS

10—fuel pump assembly
12—main pump housing
14—plunger bore
16—pumping plunger
18—pump head housing
20—pump chamber
22—inlet valve arrangement
24—housing interface
26—screw
26a—screw shaft
26b—screw head
28—screw-receiving bore in pump head housing
30—screw-threaded region of the main bore
32—unthreaded region of the main bore
34—screw-threaded interface
36—screw-threaded region of the screw shaft
38—unthreaded region of the screw shaft
40—chamfer at the end of the main bore
42—low pressure passage
44—cap for inlet valve arrangement
50—upper axial portion of main bore (counter bore region)
52—screw-threaded region of the main bore (lower axial portion)
60—screw
60a—screw shaft
60b—screw thread
62—bore in the pump head housing
64—unthreaded region of the screw shaft
66—screw threaded region of the screw shaft
70—axially-extending screw-threaded interface
71—step
72—axially-extending clearance interface
73—slope
150—extended screw-threaded region of the main bore
152—lower threaded region of the main bore
160—screw
160a—screw shaft
160b—screw head
164—unthreaded region of the screw (reduced diameter region)
166—threaded region of the screw
170—axially-extending threaded interface
172—axially extending clearance interface

1. A fuel pump assembly for a fuel system of an internal combustion engine, the fuel pump assembly comprising;
a pump head housing;
a main pump housing provided with at least a portion of a plunger bore for housing a pumping plunger which is driven in use to pressurise fuel within a pump chamber defined within the pump head housing;
the pump head housing and the main pump housing defining a housing interface between facing surfaces thereof; and
a screw-receiving bore in the main pump housing for receiving a screw comprising a screw shaft which extends across the housing interface, in use, wherein the screw-receiving bore has a screw-threaded region of diameter, D, which interfaces with a screw-threaded region of the screw shaft to define an axially-threaded interface, wherein the axially-extending threaded interface is displaced axially from the housing interface by an axially-extending clearance interface defined between the screw-receiving bore and the screw, the axially-extending clearance interface having a distance length, L, wherein a ratio of L/D is greater than or equal to 1.

2. The fuel pump assembly as claimed in claim 1, wherein the screw-receiving bore is provided with a counter-bore region, which opens at the housing interface to define the axially-extending clearance interface between the main bore and the screw shaft.

3. The fuel pump as claimed in claim 2, wherein the counter bore region is provided with a chamfer at the housing interface.

4. The fuel pump assembly as claimed in claim 1, wherein the screw-threaded region of the screw-receiving bore includes an extended screw-threaded region which extends beyond the proximal end of the axially-extending threaded interface to the housing interface, the screw having a screw shaft of reduced diameter relative to the screw-threaded region of the screw shaft to define a clearance interface with the extended screw-threaded region.

5. The fuel pump assembly as claimed in claim 4, wherein the extended screw-threaded region extends along the full length of the screw-receiving bore.

6. The fuel pump assembly as claimed in claim 1, wherein the screw-receiving bore includes an enlarged diameter region of length, L, proximal to the housing interface, which defines the axially-extending clearance interface with the screw shaft.

7. The fuel pump assembly as claimed in claim 6, wherein the screw-threaded region of the screw shaft extends beyond the axially-extending threaded interface towards the housing interface and into the enlarged diameter region.

8. The fuel pump assembly as claimed in claim 1, wherein the ratio L/D is between 1 and 1.5.

9. The fuel pump assembly as claimed in claim 1, wherein the ratio L/D is greater than or equal to 1.3.

10. The fuel pump assembly as claimed in claim 1, wherein the pump head housing is secured to the main pump housing by means of no more than two screws traversing the housing interface.
